(19) United States
(12) Patent Application Publication
(10) Pub. No.: US 2004/0120584 A1
(43) Pub. Date: Jun. 24, 2004

(54) Portable communication terminal capable of abstracting and inserting backgroud image and method thereof

(76) Inventors: Min-Keun Jang, Seoul (KR); Ju-Seong Song, Seoul (KR)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/474,563

(22) PCT Filed: Apr. 12, 2002
(86) PCT No.: PCT/KR02/00671

(30) Foreign Application Priority Data
Apr. 13, 2001 (KR) 2001-19785

(51) Int. Cl. G06K 9/36

(52) U.S. Cl. 382/232

(57) ABSTRACT

The present invention relates to a portable communication terminal for dynamic image service capable of abstracting and inserting background image, and method of separating the background image using the same. The present invention has an advantage in that the user's personal privacy could be effectively protected by transmitting the image data of which the background image is removed or other pseudo background image or pseudo dynamic image is inserted because the background image which needs to protect the user's privacy could be removed selectively according to the request of the user or a pseudo background image selected by the user or a pseudo dynamic image prepared beforehand instead of the image data of the user on communicating with dynamic image could be inserted and transmitted to the other user when communicating with dynamic image.

### BACKGROUND OF THE INVENTION

(a) Field of the Invention

The present invention relates to a portable communication terminal capable of providing a dynamic image. More precisely, it relates to a portable communication terminal providing dynamic image capable of abstracting and inserting background image, and method thereof.

(b) Description of the Related Art

Recently, portable communication terminal is on being developed as a multimedia equipment capable of providing not only voice telephone call but also various additional services such as a function for electronic note, a function for game, a function for managing schedule. Further to such tendency, thank to the data transmission speed being up to the data transmission speed of early IMT-2000 service as IS-95C being visualized, it is realized that the portable communication terminal provides not only voice but also dynamic image service that is impossible to realized at former IS-95A/B.

Said dynamic image service means a multimedia service that make it possible to display not only various VOD (video On Demand) data provided by communication providers or numerous web servers connected to the communication providers but also the dynamic image of the other person who wants to communicate with dynamic image at the portable communication terminal in real-time, and it is expected that the convenience of the user would become larger thanks to said dynamic image service.

The dynamic image communication service of said dynamic image service with which the users of the terminal could talk over the telephone seeing with each other has advantage in that one can see the other person's shape at real-time while calling. However, there is a problem in that one's personal privacy is exposed as it is because the background image in the dynamic image transmitted to the other where the user places in is also transmitted to the other person as it is even in the case that the user is in the his/her own private space where the user doesn't want to be exposed.

The present invention is created to solve the problem of the dynamic image communication service using the conventional portable communication terminal.

### SUMMARY OF THE INVENTION

Accordingly, an object of the present invention is to protect the personal privacy by preventing the transmission of real background image according to the user's choice if the user does not want to transmit the background image of present surroundings while speaking over the telephone with dynamic image using conventional portable communication terminal.

To achieve the above object, the present invention provides a portable communication terminal capable of abstracting and inserting background image, and methods thereof.

According to the present invention, when one speaks over the telephone with dynamic image using portable communication terminal one's personal privacy could effectively be protected according to the user's request by removing the background image which needs protection of one's private life, or by transmitting the image replaced with pseudo-background image selected by the user to the other side, or by transmitting pseudo-dynamic image data prepared beforehand instead of the image data of the user on communicating.

To achieve the object above-mentioned, the present invention provides a portable communication terminal capable of abstracting and inserting background image comprising; an image input unit for inputting image data from the image taken from a subject for photography; a background image processing unit for separating selectively and processing the image data inputted from said image input unit into the main image data for the user and the background image data for the background of the users backside; a CODEC unit for encoding and compressing the image data inputted from said image processing unit into certain format, and for dissolving and decoding to output the compressed image data received from the other side wirelessly; a control unit for transmitting wirelessly the image data inputted from said image processing unit after encoding via said CODEC unit and compressing it into certain format; and a display unit for displaying said image data decoded and outputted from said CODEC unit. Further, the present invention provides a method of separating the background image using portable communication terminal providing dynamic image capable of abstracting and inserting background image according to the present invention comprising steps of; (a) receiving image data of a subject for photography through said image input unit when requested for dynamic image communication mode; (b) inspecting whether there is a request to remove the background image of the image data from the user or not; (c) extracting the background image by separating said inputted image data into the main image data and the background image data by extracting the contour of said user's face if there's a request for removing said background image; (d) compressing into a certain format after encoding the image data of which said background image is extracted through said CODEC unit; and (e) wirelessly transmitting said compressed image data into said certain format to the other terminal.

### BRIEF DESCRIPTION OF THE DRAWINGS

FIG. 1 is a block diagram of portable communication terminal according to an embodiment of the present invention.

FIG. 2 is a flow chart of processing the separation of the background image according to an embodiment of the present invention.

FIG. 3 is an example of a screen of which the background image is separated according to an embodiment of the present invention.

### EMBODIMENT

Hereinafter, the present invention will be described in detail with reference to the preferred embodiments. But, those skilled in the art will appreciate that various modifications and substitutions can be made therein without departing from the spirit and scope of the present invention as set forth in the appended claims. The embodiments of the present invention are provided for illustrating the present invention more completely to those skilled in the art.

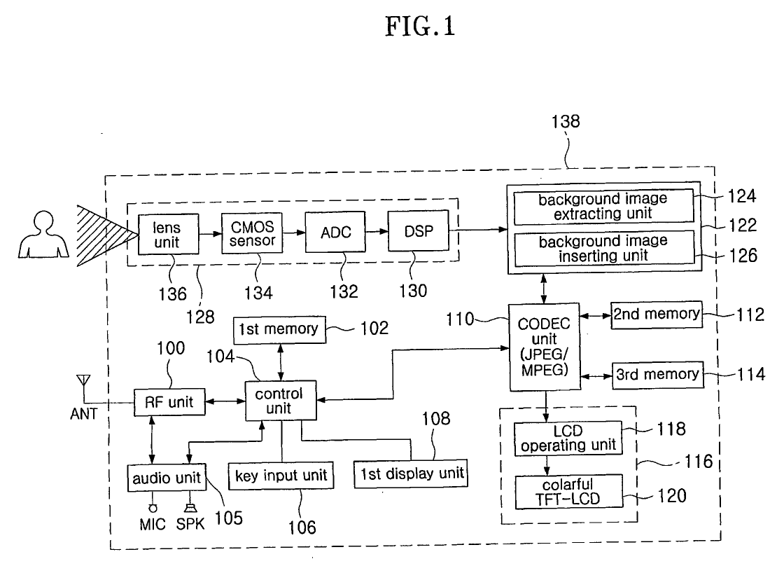

FIG. 1 is a block diagram of portable communication terminal capable of providing a dynamic image according to an embodiment of the present invention. Referring to FIG. 1, the control unit (MSM: Mobile Station Modem) (104) controls general operation of the portable communication terminal for performing voice communication and various multimedia functions. Further, it controls the Codec unit (110) to express dynamic image service when there is a request for the dynamic image communication mode from the user to dissolve and decode the image such as static image or dynamic image received wirelessly from the outer wireless communication network after dissolving the compression, and to transmit the image data inputted from the image input unit (128) to the other's terminal via wireless communication network by compressing it into a certain format of JPEG/MPEG (Joint Photographic Experts Group/Moving Picture Experts Group) after encoding.

And, if there is a request to remove the background image from the user when speaking over the telephone with dynamic image according to an embodiment of the present invention, it controls the background image processor unit (122) to transmit the image data of the user of which the background image is removed, or to transmit the image data wherein pseudo background image selected by the user is inserted into the area of the background image of the said image data. Further, if the terminal is set for the pseudo dynamic image communication mode, it transmits the pseudo dynamic image data selected by the user to the other's terminal instead of the image data including the user's shape on communicating.

This is, as mentioned above, for the purpose of preventing selectively the background image which needs protection of the user's privacy being transmitted to the other's terminal.

The 1^{st} memory (102) is saved of certain program that controls general operation of the terminal, and saves the data inputted/outputted to a certain predetermined area when the general operation of the terminal is performed by the control unit (104). RF (Radio Frequency) unit (100) means the overall composition units of high frequency processing unit, intermediate frequency processing unit and baseband processing unit. And, voice and various multimedia data received from outer wireless communication network via antenna(ANT) are processed at wireless communication band frequency firstly, then they are processed into low frequency band and then they are further processed into the frequency band signal that could be treated at the control unit (104). Furthermore, the signal is inputted to the image input unit (128) and the CODEC unit modulates the various encoded and compressed image data into wireless communication band frequency signal to transmit wirelessly to the outer wireless communication network.

The audio unit (105) modulates the voice signal inputted via microphone being controlled by the control unit (104), and demodulates the wireless signal received through the RF unit (100) and transmits to the speaker (SPK) in the form of voice signal. Further, at the dynamic image communication mode, it demodulates the wireless audio signal contained in said image data received from said RF unit (100) and outputs it reproductively through the speaker (SPK). The key input unit (106) comprises plurality of number key and dynamic image communication mode key for dynamic image service, and when the user inputs a certain key, a key data is generated and outputted to the control unit (104). The 1^{st} display unit (108) comprises a black-and-white LCD (Liquid Crystal Display) that displays various informations of the terminal at the commercial communication mode by way of gray level, and displays the inputted signal of various information received from the control unit (104) and key data generated by the key input unit (106). The 2^{nd} display unit (116) displays the image data received from the image input unit (128) or from the outer wireless communication network in the case of dynamic image communication mode, and comprises a colorful TFT-LCD (120) for displaying said image, and LCD operating unit (118) to operate the colorful TFT-LCD according to the control of the control unit (104) to display said various image data inputted from the CODEC unit (110) on the TFT-LCD.

The image input unit (128) is for the dynamic image service, and offers the image data of the user's shape and various background images existing at the backside of the user to the CODEC unit (110) it the case of dynamic image communication mode. The operation is as follows. The image of a subject for photography is provided to CMOS sensor (134) through the lens unit (136). Then, the CMOS sensor (134) converts and outputs the optical signal of the subject passed through the lens unit (136) into the electric signal (image pickup signal), and performs functions of the camera such as exposure, gamma, gain control, white balance, color matrix. Subsequently, ADC (Analog-to-Digital Converter) (132) converts 1 field part of the image pickup signal gain-controlled into the digitalized signal to output to the DSP (Digital Signal Processor) (130). The DSP (130) converts the digitalized 1 field part of the image pickup signal into NTSC (National Television System Commitee) or PAL (Phase Alternation by Line) type image signal.

The background image processing unit (122) comprises the background extracting unit (124) that separates and extracts the image data of the background image from said inputted image data by extracting the contour line of the user's face inputted from said image input unit (128) and the background image inserting unit (126) that inserts the pseudo background image data into the area where said background image is extracted if there's a request to display the pseudo background image from the user. Said background image processing unit (112) removes the background image data of the backside image for the user of the image data inputted from said image input unit (128) according to the control of the control unit (104) or inserts the pseudo background image data being requested to insert by the user into the inputted image data of which said background image is removed and transmits it to the CODEC unit (110).

The CODEC unit (110) converts the image pickup signal (Y, C) provided from the image input unit (128) according to the control of the control unit (104) into JPEG or MPEG format, and compresses it into a certain ratio, and dissolves the compression of the image data received wirelessly from the outer wireless communication network and offers it to the 2^{nd} display unit (116) after decoding. The image data received wirelessly from said outer wireless communication network might be an image data transmitted from the other's terminal on communicating or might be various VOD data provided by Web Server or numerous Image Contents Server connected to Mobile Switching Center. The 2nd memory (112) connected to the CODEC unit (110) is a memory for saving a program to perform various operation of the CODEC unit (110), commercially it is expressed by SRAM (Static Random Access Memory), and the 3^{rd} memory (114) is a memory for saving the image data inputted through the lens unit (136) in the image input unit (128) and the image data received from the outer wireless communication network, and is expressed by flash memory.

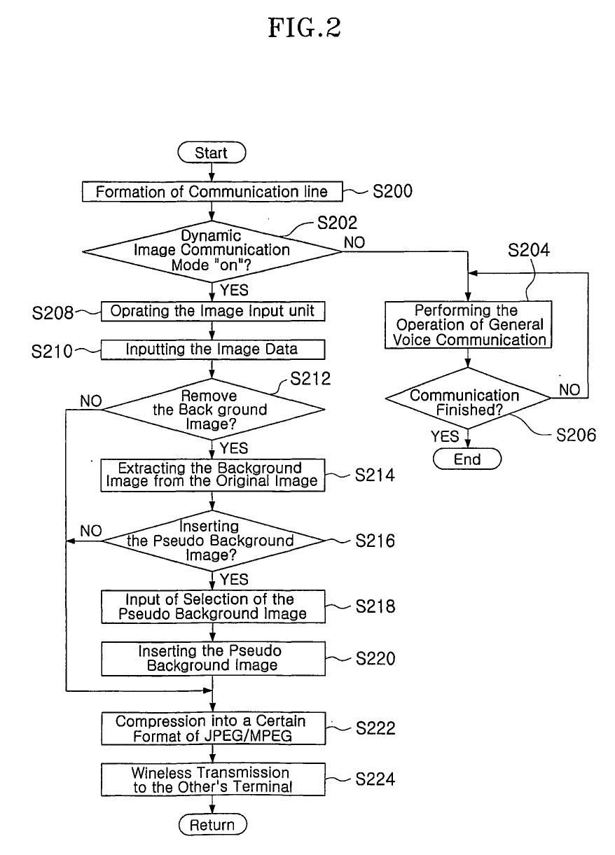

FIG. 2 is a flow chart of processing the removal of the background image and the insertion of the pseudo background image according to an embodiment of the present invention. Hereinafter, a preferred embodiment of the present invention will be described in detail with reference to FIG. 1 and FIG. 2. Though, in the embodiment of the present invention a flow to control the operation of removing the background image and the inserting the pseudo background image is explained in detail, but this is only for the convenience of explanation, it could be applicable for the case of the pseudo dynamic image mode the same as the pseudo background image insertion mode.

At first, the control unit (104) inspects whether there is a request for the dynamic image communication mode from the user or not by processing (S202) step when a communication line is formed between the portable communication terminals at (S200) step. If the user doesn't input the dynamic image mode key to express the dynamic image communication service, the control unit (104) processes to (S204) step to perform commercial operation for general voice communication. Next, the control unit (104) proceeds to (S206) step to inspect whether or not the communication is ended, and if the communication is not ended, returns to (S202) step to inspect whether there is a request for the dynamic image communication mode or not.

On the other hand, if the user inputs the dynamic image communication mode key to request for the dynamic image communication service at said (S202) step, the control unit (104) responds to it and processes (S208) step to operate each constituent element of the image input unit (128) for inputting the image data of the user on communicating. According to this, the dynamic image for the user's shape and for the backside background image of the user inputted through the lens unit (136) in the image input unit (128) is inputted by being converted into image data being passed through CMOS sensor (134), ADC (132) and DSP (130), and, the control unit (104) receives the image data for the user's shape and for the background image from said image input unit (128) at (S210) step.

Subsequently, the control unit (104) proceeds to (S212) to inspect whether there is a request to remove the background image from the user or not. At this time, said background image is, as mentioned above, the image that could expose the user's privacy in the case of the dynamic image communication mode, and if the user does not want to expose the background image to the user on the other terminal, the user could request to remove the background image. Therefore, if there is a request to remove the background image from the user, the control unit (104) responds to this at (S212) step and proceeds to (S214) step and removes the background image data for the backside background of the user by extracting from the inputted image data.

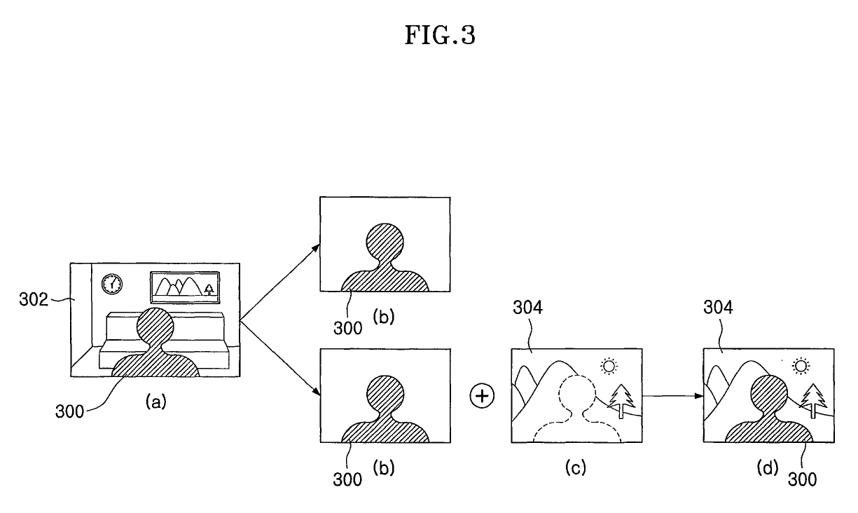

Namely, as shown at FIG. 3 that represents an example of removing and inserting the background image according to an embodiment of the present invention, from the original image inputted from the user depicted at (a) of FIG. 3 consisting of the main image (300) for the user's shape and the background image (302) for the backside background of the user's shape remains only the main image (300) for the user's shape by being removed of the background image (302) as shown at (b) of FIG. 3 by being passed through said (S214) step. Thus, when the background image (302) is an image that requires protection of personal privacy, transmission of it to the other's terminal could be prevented.

Next, the control unit (104) proceeds to (S216) step and inspects whether there is a request to insert the pseudo background image from the user or not. At this time, said pseudo background image means a background image inserted into the area of the removed background image from said inputted image data by being selected by the user, and the user has edited and saved beforehand various background images which are not related to his/her own privacy, and requests to insert of said pseudo background image into the area of original background image selecting what he/she wants. In this case, if there is no request to insert the pseudo background image from said user, the control unit (104) responds to this at said (S216) step and proceeds to (S222) step to control said CODEC unit (110) to compress the image data of which said background image is removed into a certain format such as JPEG or MPEG, and transmits said image data of the user compressed into a certain format wirelessly to the outer wireless communication network through the RF unit (100) at (S224) step.

On the other hand, if there is a request to insert the pseudo background image from the user, the control unit (104) responds to this at (S216) step and proceeds to (S218) step to request for the user to select the pseudo background image to be inserted into the area where the background image is removed from the inputted image data and receives the input. Subsequently, the control unit (104) controls the background image inserting unit (126) of said background image processing unit (122) at said (S220) step to insert the pseudo background image inputted from the user at said (S218) step into the area of the background image of said inputted image data.

That is, as shown at FIG. 3, the user selects and requests to insert the pseudo background image that he want into the area of the background image of the image depicted at (b) of FIG. 3 of which said background image (302) is removed. According to this, it would be possible to generate an image composed of main image of the user depicted at (d) of FIG. 3 with the pseudo background image (304) by inserting the pseudo background image (304) depicted at (c) of FIG. 3 into the area of the background image of which the background image depicted at (b) of FIG. 3 is eliminated through the background image inserting unit (126). Accordingly, if said background image (302) is an image which needs protection of one's personal privacy, the pseudo background image (304) selected by the user instead of the background image (302) of the original image is transmitted to the other's terminal to protect one's personal privacy.

Next, the control unit (104) proceeds to (S222) step to compress the image data of which said background image is eliminated into a certain format such as JPEG or MPEG, and transmits the image data of the user compressed into said certain format wirelessly to the outer wireless network through RF unit (100).

According to this, as mentioned above, in the portable communication terminal capable of dynamic image service, one's personal privacy could be effectively protected by removing the background image which needs protection of one's personal privacy when communicating with dynamic image, or inserting other pseudo background image to transmit it to the other's terminal.

While the present invention has been described in detail with reference to the preferred embodiments, those skilled in the art will appreciate that various modifications and substitutions can be made therein without departing from the spirit and scope of the present invention as set forth in the appended claims.

### Industrial Applicability

The present invention disclosed as above has an advantage in that the user's personal privacy could be effectively protected by making it possible to remove the background image which needs protection of the user's privacy and to insert other pseudo background image when communicating with dynamic image using the portable communication terminal capable of dynamic image service, and to transmit pseudo background image data instead of the image data of the user on communicating.

What is claimed is:

1. A portable communication terminal capable of extracting and inserting background image that could provide dynamic image communication services comprising:
an image input unit for inputting image data from the image taken from a subject for photography;
a background image processing unit for separating selectively and processing the image data inputted from said image input unit into the main image data for the user and the background image data for the background of the user's backside;
a CODEC unit for encoding and compressing the image data inputted from said image processing unit into certain format, and for dissolving and decoding to output the compressed image data received from the other side wirelessly;
a control unit for transmitting wirelessly the image data inputted from said image processing unit after encoding via said CODEC unit and compressing it into certain format; and
a display unit for displaying said image data decoded and outputted from said CODEC unit.

2. The portable communication terminal capable of extracting and inserting background image according to claim 1, wherein said image input unit comprises:
a lens unit for receiving the image of the subject;
a CMOS sensor for converting and outputting the optical signal of the subject passed through said lens unit into electric signal;
ADC for converting the image signal gain-controlled into digital signal; and
DSP for converting the digitalized image signal inputted from said ADC into NTSC or PAL typed image signal.

3. The portable communication terminal capable of extracting and inserting background image according to claim 1, wherein said background image processing unit comprises:
a background extracting unit for separating and extracting the image data of the background image from said inputted image data; and
a background image inserting unit for inserting pseudo background image data into the area where said background image extracted according to the request to display the pseudo background image from the user.

4. The portable communication terminal capable of extracting and inserting background image according to claim 3, wherein said background image extracting unit extracts the image data for the background image by extracting the contour line of the user's face of the inputted image taken at said lens unit.

5. The portable communication terminal capable of extracting and inserting background image according to claim 3, wherein said background image inserting unit further comprises a background image memory for storing various background image data to be displayed at the area of the background image of the image data of which the background image is removed.

6. A method of separating the background image at the portable communication terminal capable of dynamic image communication comprised of a image input unit, a background image processing unit, a CODEC unit and a control unit comprising steps of:
(a) receiving image data of a subject for photography through said image input unit when there is a request for the dynamic image communication mode;
(b) inspecting whether there is a request to remove the background image of the image data from the user or not;
(c) extracting the background image by separating said input image data into the main image data and the background image data through extracting the contour of said user's face if there's a request to remove said background image;
(d) compressing into certain format after encoding the image data of which said background image is extracted via said CODEC unit; and
(e) transmitting said compressed image data into said certain format wirelessly to the other terminal.

7. A method of separating the background image according to claim 6 comprising steps of:
(f) receiving a pseudo background image selected by the user if there is a request to insert the pseudo background image into the image data of which said background image is removed after (c) step of extracting the background image;
(g) inserting said selected pseudo background image into the area of the background image of said image data;
(h) compressing said image data in which pseudo background image is inserted into a certain format via said CODEC unit after decoding; and
(i) transmitting said image data compressed into a certain format wirelessly to the other terminal.

8. A method of separating the background image according to claim 6 comprising steps of:
(f′) receiving a pseudo dynamic image selected by the user if there is a request to display the pseudo background image into the image data of which said background image is removed after (c) step of extracting the background image;
(g′) compressing said selected pseudo dynamic image data into a certain format via said CODEC unit after decoding; and
(l′) transmitting said pseudo dynamic image data compressed into a certain format wirelessly to the other terminal.

9. A method of separating the background image according to claim 6, wherein said pseudo dynamic image data is one of various kinds of dynamic data stored beforehand.
